(19) United States
(12) Patent Application Publication
(10) Pub. No.: US 2025/0304068 A1
(43) Pub. Date: Oct. 2, 2025

(54) SYSTEM AND METHOD FOR MACHINE CONTROL USING ROAD SURFACE QUALITY DATA

(71) Applicant: Caterpillar Inc., Peoria, IL (US)

(72) Inventors: Maung Thant Zin Shein, Bulleen (AU); Jyoti Prakash Mishra, Brunswick West (AU); Aaron Francis Westbury, Wynyard (AU)

(73) Assignee: Caterpillar Inc., Peoria, IL (US)

(21) Appl. No.: 18/617,360

(22) Filed: Mar. 26, 2024

(51) Int. Cl. B60W 30/18; B60W 40/06

(52) U.S. Cl. CPC B60W 30/18; B60W 40/06; B60W 2552/35; B60W 2556/45; B60W 2720/10

(57) ABSTRACT

Machines at a worksite are configured to operate autonomously e.g., travel within and/or to perform tasks at a worksite when commanded by a remote operator station (ROS). The ROS may further be able to command modifications in the operations of individual machines at the worksite based at least in part on the locations of those machines at the worksite and the conditions of the traveling surfaces at respective ones of those locations. A machine may transmit to the ROS road surface quality (RSQ) index values representative of the quality of the surface traversed by the machine. The ROS uses the RSQ index values to determine zones at the worksite where machine operations are to be modified, such as sped up or slowed down, based on the quality of the surface in those zones. By controlling the speeds of the machines based on surface conditions, the machines experience reduced wear and tear.

### TECHNICAL FIELD

The present disclosure generally relates to autonomous machines at a worksite, and in particular, to determining quality of travel surfaces at the worksite and automated control of the machines and/or a worksite management system based on the quality of the surfaces to be traversed at the worksite.

### BACKGROUND

A machine may be a self-propelled vehicle or autonomous vehicle. Thus, worksites, such as construction sites, mining sites, farms, may have one or more machines working thereon, that are controlled remotely, such as from a remote operator station. These machines may be autonomous, semi-autonomous, or manually operated by operators onboard these machines. The machines may perform a variety of tasks, such as hauling material, excavating rocks or ores from a mining site, extracting oil or other natural resources, planting or harvesting at a farm site, building structures or roads at a construction site. For example, such machines may be construction machines such as bulldozers, wheel loaders, graders, compaction machines, off-highway trucks, and other earth-moving equipment or construction equipment typically found at a worksite. When a job is in process, various machines may be deployed to perform multiple, and possibly unique, tasks at different locations within the worksite. For example, an excavator may be used to excavate a trench at one location and a haul truck may be used to haul away the excavated material from the trenches.

While these remotely controllable and/or autonomous machines improve efficiency at a worksite, the lack of human judgement may prevent the machines from altering their operations responsive to conditions at the worksite. Human operated machines may be more granular in reacting to conditions at the worksite than some remotely operated machines. A remote operator of the machines at the worksite may lack knowledge of the conditions at different parts of the worksite, and therefore, may not be as adept at changing the operation of remotely controlled and/or semi-autonomous machines at a worksite compared to a human operator of the machine. Lacking the ability to modify the operation of remotely controlled machines at a worksite may reduce the overall efficiency and longevity of the machines. For example, a remote controlled machine, such as a machine controlled from a remote operator station, may not slow down for impediments (e.g., potholes, rough surfaces, dropped materials along pathway, etc.) at a worksite, which can cause damage and/or accelerate maintenance timelines of machines at the worksite.

U.S. Patent Publication 2019/0154440 (hereinafter, “the '440 reference”) describes using accelerometer data to identify poor road conditions in an underground mining operation. The '440 reference discloses that the identified poor road conditions are used to alert personnel to take corrective actions, such as repair the poor road. However, there is a need for further improvements, such as road quality data that can be used to improve drivability and/or navigability.

Systems and methods are needed for overcoming the deficiencies described above.

### SUMMARY

In an aspect of the present disclosure, a system includes an antenna, an accelerometer, a remote operating station (ROS) including a processor, at least one electronic control module (ECM) in communication with the antenna and the accelerometer, and a non-transitory computer-readable media having stored thereon computer-executable instructions. The computer instructions, when executed, cause the at least one ECM to receive vertical acceleration data from the accelerometer as a machine traverses a surface, determine, based at least in part on the series of vertical acceleration data, a series of road surface quality (RSQ) index values, send, as a wireless signal via the antenna, the series of RSQ index values to the ROS, receive, from the ROS, a command to implement in a change in speed of the machine based at least in part on the received series of RSQ index values, and implement the change in speed of the machine.

In another aspect of the present disclosure, a method includes receiving, from an accelerometer of a machine and by an electronic control module (ECM) of the machine, acceleration data and generating, by the ECM and based at least in part on the acceleration data, a down-sampled acceleration data by deleting one or more individual ones of the acceleration data. The method further includes generating, by the ECM, anti-aliasing filtered and down-sampled acceleration data by applying an anti-aliasing filter to the down-sampled series of acceleration data, generating, by the ECM, road surface quality (RSQ) index values by determining a moving average of a square of the anti-alias filtered and down-sampled series of acceleration data, sending, by the ECM and to a remote operating station (ROS), the RSQ index values, receiving, by the ECM and from the ROS, a command to change a route of the machine, wherein the command is based at least in part on the RSQ index values, and implementing, by the ECM, the change in the route of the machine.

In yet another aspect of the present disclosure, a machine includes an antenna, an accelerometer, an electronic control module (ECM) in communication with the antenna and the accelerometer, and non-transitory computer-readable media storing computer-executable instructions. The computer executable instructions, when executed, cause the ECM to receive vertical acceleration data from the accelerometer as the machine traverses a surface, determine, based at least in part on the vertical acceleration data, a series of road surface quality (RSQ) index values, determine, based at least in part on the series of RSQ index values, that the machine is to change at least one of speed or route, and implement the change of at least one of the speed or the route.

### BRIEF DESCRIPTION OF DRAWINGS

FIG. 1 is a schematic illustration of an example machine configured to be controlled remotely, according to examples of the disclosure.

FIG. 2 is a schematic illustration of an example worksite where various machines are remotely controlled, according to examples of the disclosure.

FIG. 3 illustrates a flowchart that depicts an example method for operating a machine while taking into consideration the worksite surface conditions, according to examples of the disclosure.

FIG. 4 illustrates a block diagram that depicts an example method for determining worksite surface conditions and controlling machines at the worksite, according to examples of the disclosure.

FIG. 5 is a schematic illustration of an example map of the example worksite of FIG. 2 with various operating zones, according to examples of the disclosure.

FIG. 6 is a block diagram of an example remote operator station that provides commands to machines at the worksite, according to examples of the disclosure.

FIG. 7 is a block diagram of an example automation electronic control module that provides RSQ index data to the remote operator station, according to examples of the disclosure.

The following detailed description of the drawings provides references to the accompanying figures. In the figures, the left-most digit(s) of a reference number identifies the figure in which the reference number first appears. The use of the same reference numbers in different figures indicates similar or identical items. The systems depicted in the accompanying figures are not to scale, and components within the figures may be depicted not to scale with each other.

### DETAILED DESCRIPTION

This disclosure describes technology related to operating a fleet of machines at a worksite. The machines may be, for example, autonomous or semi-autonomous machines that can be remotely controlled from a remote operator station at the worksite. The commands used to remotely operate the machines may be based, at least in part, on determined surface quality at various portions of the worksite.

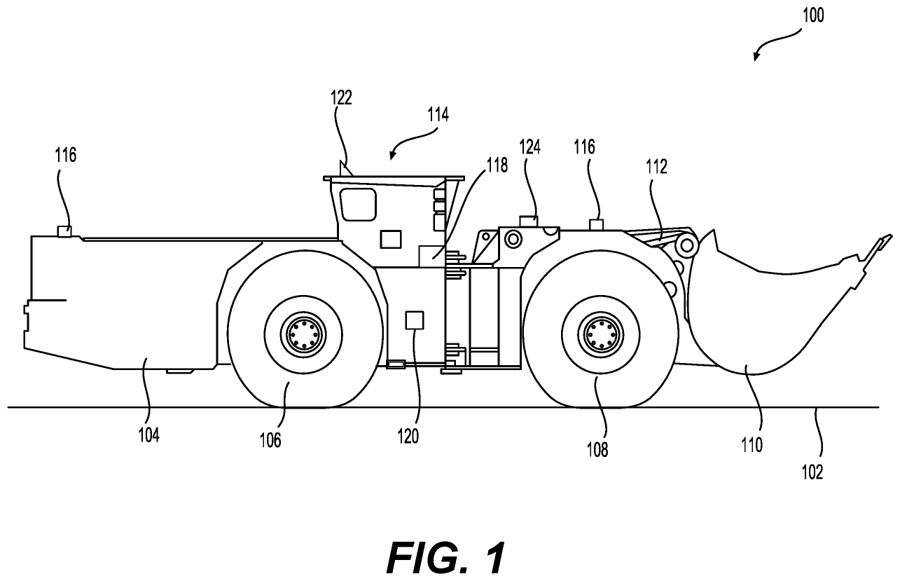

FIG. 1 is a schematic illustration of an example machine 100 configured to be controlled remotely, according to examples of the disclosure. The electric machine 100, although depicted as a front loader type of machine, may be any suitable machine, such as any type of loader, dozer, dump truck, skid loader, excavators, compaction machine, backhoe, combine, crane, drilling equipment, tank, trencher, tractor, combinations thereof, or the like. The machine 100 is configured for propulsion using any variety of internal combustion engines, electric motor(s), or both internal combustion engines and electric motor(s).

The machine 100 is illustrated as a loader machine, which is used, for example, for loading trucks, moving heavy construction materials and/or equipment, moving mined materials (e.g., minerals, ores, etc.), road construction, digging, boring, construction, and other such mining, paving, and/or construction applications. For example, such a machine 100 is used in situations where materials, such as loose stone, gravel, soil, sand, concrete, and/or other materials of a worksite need to be transported over a surface 102 at the worksite. The machine 100 may be operated in the open air or underground, such as in a mining tunnel.

As disclosed herein, the machine 100 may also be in the form of a dozer, where the electric machine may be used to redistribute and/or move material on the surface 102. For example, a dozer is configured to distribute soil or gravel over the surface 102. Further still, the machine 100 may be in the form of a mining truck that can carry ores and/or minerals, both overground and underground, in a mining worksite. It should be understood that the machine 100 can be in the form of any other type of suitable construction, mining, farming, military, and/or transportation machine. In the interest of brevity, without individually discussing every type of construction and/or mining machine, it should be understood that the road surface monitoring and machine 100 control, as described herein, may be applied to a wide variety of machines 100.

As shown in FIG. 1, the example machine 100 includes a frame 104, a first set of wheels 106, and a second set of wheels 108. The first set of wheels 106 and/or the second set of wheels 108 are mechanically coupled to transmission elements (not shown) and/or one or more drive motors (not shown). When in motion, the first set of wheels 106 and/or the second set of wheels 108 rotate to enable the electric machine 100 to traverse the surface 102. Although illustrated in FIG. 1 as having a hub with a rubber tire, in other examples, the first set of wheels 106 and/or the second set of wheels 108 may instead be in the form of drums and/or chain drives.

The frame 104 of the machine 100 may be constructed from any suitable materials, such as iron, steel, aluminum, other metals, ceramics, plastics, or the combination thereof. The frame 104 may be of a unibody construction in some embodiments, and in other embodiments, may be constructed by joining two or more separate body pieces. Parts of the frame 104 may be joined by any suitable variety of mechanisms, including, for example, welding, bolts, screws, other fasteners, epoxy, combinations thereof, or the like.

The machine 100 may include a bucket 110 or other moveable elements configured to move, lift, carry, and/or dump materials. The bucket 110 may be used, for example, to pick up and carry dirt from one location on the surface 102 to another location of the surface 102. The bucket 110 may be actuated by one or more hydraulic systems 112, or any other suitable mechanical systems.

With continued reference to FIG. 1, the machine 100 also includes an operator station 114. Thus, in some cases, the machine 100 may be configured to operate with an operator in the machine 100. According to examples of the disclosure, the machine 100 may also be configured to operate in a semi-autonomous way, in which the machine 100 is controlled remotely, rather than by a person seated in the operator station 114.

The machine 100 may include one or more inertial measurement units (IMU), such as accelerometers 116. The accelerometers 116, collecting acceleration measurements during operation of the machine 100 provides the data to determine the worksite surface quality. The accelerometers 116 may provide a variety of data, including acceleration in the vertical direction (e.g., z-direction, orthogonal to the direction of movement of machine 100, etc.). The accelerometers 116 may be of any suitable type, such as a micro-electromechanical systems (MEMS) accelerometer. Alternatively, other types of IMU sensors may be used, such as spring-based accelerometers, gyroscopes, or the like.

In example embodiments, each of the accelerometers 116 may provide a stream of vertical acceleration data. The stream of vertical acceleration data may be at any suitable frequency, such as 200 Hz, 100 Hz, 50 Hz, or the like. The accelerometers 116 may have any suitable range and/or sensitivity. As a non-limiting example, accelerometers 116 may have a range of about ±20 g. Other example ranges for the accelerometers 116 may include ±5 g, ±10 g, and/or ±30 g. As a non-limiting example, accelerometers 116 may have a resolution of about 2922 μg. Other example resolution for the accelerometers 116 may include 500 μg, 1000 μg, 2000 μg, 3000 μg, and/or 4000 μg. In some cases, the accelerometers 116 may be of the same type and of same or similar specifications. In other cases, such as if the weight distribution of the machine 100 between its front and back is relatively asymmetric, the accelerometers 116 may be of different types and/or of different specifications.

Each of the accelerometers 116 may be mounted to the frame 104 of the machine 100 such that each accelerometer 116 is indicative of the vibrations (e.g., vertical displacement) experienced in different parts of the machine 100. For example, one of the accelerometers 116 may be disposed near the front of the machine 100 and vertical acceleration measurements therefrom may be indicative of surface impediments traversed by the front wheels 108. Similarly, the other of the accelerometers 116 may be disposed near the rear of the machine 100 and vertical acceleration measurements therefrom may be indicative of surface impediments traversed by the rear wheels 106.

Although two separate accelerometers 116 are depicted, it should be understood that there may be any number of accelerometers 116, such as one accelerometer 116, three accelerometers 116, or four accelerometers 116. With two accelerometers 116 there is sufficient measurement data to provide a redundant verification of results. For example, one accelerometer 116 may provide vertical acceleration data when the front wheels 108 traverse an obstacle at the worksite and the other accelerometer 116 may provide a redundant and/or verifying set of vertical acceleration data when the rear wheels 106 traverse the same obstacle.

Although the accelerometers 116, or other type(s) of IMU(s), provide a wide range of data, such as x-direction acceleration and y-direction acceleration, it may be the z-direction acceleration data or vertical acceleration data that may be used to determine a road surface quality (RSQ) index value. It is this RSQ index value that is compared to one or more threshold values to determine whether the operation of the machine 100 ought to be modified responsive to the level of impediments on the traversable surface of the worksite.

The machine 100 may further include a main electronic control module (ECM) 118. This main ECM 118 may receive signals (e.g., instructions, commands, etc.) indicative of the desired operations of the machine 100 and then the main ECM 118 may implement those desired operations. The signals commanding the desired operation of the machine 100 may be received from any variety of sources, including remote sources that control the operation of the machine 100 at a worksite. For example, the main ECM 118 may control the operation of the engine, motors, transmission, steering, the bucket 110 or other implements of the machine 100, the hydraulic system 112, etc.

In some cases, the main ECM 118 may also receive signals from the accelerometers 116 and be configured to process the signals from the accelerometers 116 to determine RSQ index values. In other cases, the main ECM 118 may cooperate with an automation ECM 120 to determine and communicate the RSQ index values, which are then used to identify the roughness and/or impediments on the surfaces, such as along pathways and/or roadways of the worksite. It should be understood that while the disclosure herein discusses particular demarcations of the operations of the main ECM 118 and the automation ECM 120 in determining the RSQ index values and communicating the same to a remote operator station, any of the functions attributed to either of the main ECM 118 and the automation ECM 120 could be performed by the other of the main ECM 118 and the automation ECM 120. In fact, in some cases, all of the functions for determining the RSQ index values may be performed by only the main ECM 118 or only the automation ECM 120.

In examples of the disclosure, the main ECM 118 may receive a sequence of data from one or both of the accelerometers 116. The sampling frequency from the accelerometers 116 may be any suitable frequency, such as, for example, 100 Hz. The main ECM 118 may receive the accelerometer data from the accelerometers 116 and optionally discard some of that data. For example, the main ECM 118 may discard data other than vertical acceleration data (e.g., z-direction acceleration data). The main ECM 118 may further optionally down-sample the received accelerometer data. For example, data received at 100 Hz may be down-sampled to 50 Hz, such as by discarding every other data point of the streaming accelerometer data. In this case, dominant frequencies from surface traversing vibrations due to poor surface conditions can be captured. It should be understood that aforementioned frequency of data are examples for illustrative purposes, and the disclosure contemplates a wide variety of frequencies of received accelerometer data and optionally down-sampled data.

According to examples of the disclosure, the main ECM 118 may provide the down-sampled accelerometer data (e.g., down-sampled acceleration in the vertical direction) to the automation ECM 120. The transference of data between the main ECM 118 and the automation ECM 120 may be via any suitable wired or wireless communication mechanism, such as a controller area network (CAN) bus, Bluetooth, Wi-Fi direct, or the like. In some cases, the down-sampling of the accelerometer data may be performed so enable the transference of the accelerometer data from the main ECM 118 to the automation ECM 120 over relatively low to medium bandwidth channels.

The automation ECM 120, upon receiving the down-sampled accelerometer data, may perform a variety of subsequent processing to generate a sequence of RSQ index values that are indicative of the quality of the worksite surface traversed by the machine 100. For example, the automation ECM 120 may process the down-sampled accelerometer data through an anti-aliasing filter or low-pass filter (LPF). Anti-aliasing processing may eliminate high frequency signals/noise in the down-sampled accelerometer data that may cause aliasing errors in determining the RSQ index values. In some cases, the relatively higher frequency signals from the accelerometers 116 may be representative of acceleration/vibration resulting from sources other than the worksite surface roughness, such as engine vibration. As a result, filtering out these higher-frequency components may result in a more robust representation of surface quality of the surfaces traversed by the machine 100. As a non-limiting example, the automation ECM 120 may filter out, by way of an LPF, frequencies above 25 Hz. It should be noted that this is an example value, and the filter threshold may be greater than or less than 25 Hz. In general, according to examples of the disclosure, the pass frequencies may be such that the Nyquist-Shannon criterion is met, where the down-sampled sampling frequency is at least double the maximum frequency of interest in the accelerometer data.

The automation ECM 120 may further generate the RSQ index as a sequence of RSQ index values (RSQⱼ). In examples of the disclosure, the automation ECM 120 may calculate the RSQ index values as a scaled moving average of the vertical acceleration data squared (e.g., the down-sampled vertical acceleration data squared or the low-pass/anti-aliasing filtered vertical acceleration data squared or the down-sampled and low-pass/anti-aliasing vertical acceleration data squared). The RSQ index values may be calculated as shown in Equation 1.

$$R S {Q}_{j} = \frac{α}{N} {\sum }_{k = j - N}^{j} {( {\ddot{z}}_{k} )}^{2} \qquad ( Equation 1 )$$

Where N defines the length of the moving-average window and a is a unit-less scaling factor used to bring computed RSQ values to a consistent and/or user-friendly magnitude for analysis and/or display. The \ddot{z}ₖ is one of the vertical acceleration data from the accelerometers 116, the down-sampled vertical acceleration data, the low-pass/anti-aliasing filtered vertical acceleration data, or the down-sampled and low-pass/anti-aliasing filtered vertical acceleration data, depending on whether optional down-sampling and/or anti-aliasing filtering is performed on the vertical acceleration data. In a non-limiting example, N may be equal to 50. In this example, if the down-sampled frequency is 50 Hz, then the moving average window to determine the RSQ index values may represent one second of time. However, it should be understood that the aforementioned values are just an example set of sampling and moving average parameters and the disclosure contemplates any suitable values and further contemplates different sets of sampling and/or moving average parameters for different types of machines 100.

The machine 100 further includes an antenna 122 to communicate wirelessly and a location sensor 124, such as a global navigation satellite sensor (GNSS), global positioning satellite (GPS) sensor, LiDAR, SONAR, and/or RADAR, for determining the location of the machine 100. The automation ECM 120 may receive location data, either directly from the location sensor 124 or via the main ECM 118. In some cases, such as in underground operations, the location sensor 124 may include LiDAR, along with a localization algorithm to determine its position. The location sensor 124 may further other onboard sensors and/or a pre-surveyed site map to indicate its location relative to other features at the worksite. The automation ECM 120 may further communicate the RSQ index values, as well as corresponding location data, to a remote operating station wirelessly via the antenna 122.

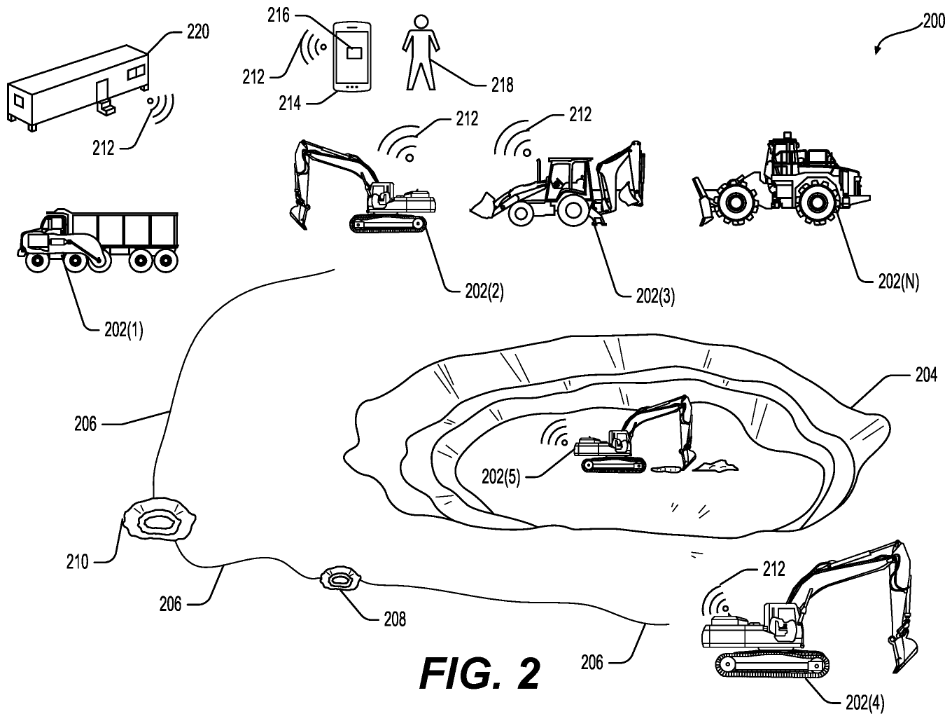

FIG. 2 is a schematic illustration of an example worksite 200 where various machines 202(1), 202(2), 202(3), 202(4), 202(5) . . . 202(N) are remotely controlled, according to examples of the disclosure. These machines 202(1), 202(2), 202(3), 202(4), 202(5) . . . 202(N), hereinafter referred to individually as machine 202 or collectively as machines 202, are configured for performing various tasks at the worksite 200. The machines 202 may be various examples of machine 100 and may include the components of machine 100, such as the accelerometers 116, the main ECM 118, and/or the automation ECM 120. In other words, the machines 202 are configured to perform some or all the functionality described with respect to machine 100, in conjunction with FIG. 1.

The machines 202, although depicted here as a haul truck 202(1), an excavator 202(2), a backhoe 202(3), etc. may be any suitable type of machine or tool that may be used in any variety of industries, such as construction, mining, farming, transportation, security services, oil and gas, etc. For example, the machine 202 may be any suitable machine 202, such as any type of loader, dozer, dump truck, skid loader, excavator, compaction machine, backhoe, combine, crane, drilling equipment, tank, trencher, tractor, grading machine, articulated truck, asphalt paver, backhoe loader, cold planer, drill, forest machine, hydraulic mining shovel, material handler, motor grader, off-highway truck, pipelayer, road reclaimer, track loader, underground machine, utility vehicle, wheel loader, tanker (e.g., for carrying water or fuel), combinations thereof, or the like.

The machines 202 are configured to receive an indication of a desired movement or mobilization corresponding to completion of a worksite task and move according to the desired movement. Thus, the machines 202 are autonomous or semi-autonomous and move automatically according to the desired movement, when commanded to perform the desired movement. In other words, the machines 202 may be remotely provided instructions, which are then executed by the machines 202, such as by the automation ECM 120 and/or the main ECM 118. However, the worksite 200 may also include other machines that are human-operated and are not remotely controlled. The machines 202 may be configured to, individually or in cooperation with each other, perform a commercial or industrial task, such as mining, construction, energy exploration and/or generation, manufacturing, transportation, agriculture, or any task associated with other types of industries. Although six machines 202 are depicted here, it should be understood that there may be any suitable number of machines 202 at a worksite 200, according to examples of the disclosure.

The worksite 200 includes a variety of different locations in which or to which the machines 202 may be maneuvered, staged, maintained, stored, parked, supplied, and/or used to perform work. The worksite 200 may include, for example, a work area 204 at which the machines 202 engage in work activities, such as digging dirt, distributing asphalt, redistributing gravel, harvesting wheat, or the like. Although the work area 204 is depicted as an open pit mine, it should be understood that the work area 204 may be any suitable location in any suitable application, such as construction, mining, farming, transportation, or the like. For example, the work area 204 may be in the form of a paving site, an industrial site, a factory floor, a building construction site, a road construction site, a quarry, a building, a city, etc. It should further be understood that the work area 204 may be underground, such as an underground mine. It should further be understood when all or portions of the worksite 200 are underground, the machines 202 may be controlled, according to the disclosure herein, while underground.

The worksite 200 may further include pathways 206 that are typically traversed at the worksite by machines 202. In a typical worksite 200 a variety of machines 202 may traverse the same or similar surfaces, rendering those surfaces the pathways 206. It is on these pathways 206 where the machines 202 may move autonomously when instructed to do so. As shown the pathways may include various roughness, impediments, obstacles, or the like, such as potholes 208, 210. Other impediments may include uneven dirt, rocks, gravel, such as mineral ores that may have fallen from one of the machines 202 onto the pathway 206. Still other impediments may include dropped construction materials, such as concrete blocks, wooden planks, bags of construction materials, etc. Indeed, any material over which a machine 202 may travel to cause that machine 202 to have vertical movement may be considered an impediment.

As shown, the pothole 210 is larger than pothole 208. As such, when a machine 202 travels over the pothole 210, the level of vertical acceleration of the machine 202 may be greater than when the same machine 202 travels over the pothole 208. Thus, the wear and tear and/or damage imparted to the machine 202, when traveling over the pothole 210 may be greater than when the same machine 202 is traveling over the pothole 208. When a human operator drives a non-autonomous machine over the potholes 208, 210, they may slow down to avoid wear, tear, and/or damage to the human operated machine. Furthermore, when the human operator drives a non-autonomous machine over the potholes 210, they may slow down more than how much they slow down when driving over the pothole 208. The apparatus, systems, and methods disclosed herein enable autonomous machines 202 to operate in a similar manner to human operated machines, where the autonomous machines 202 slow down when traveling over impediments, and further slow down more when traveling over bigger impediments.

The machines 202 may receive wireless signal(s) 212 via their antennas 122 from a remote operating station (ROS) 214, running fleet management software 216. The wireless signal 212, as received by the machine 202 may carry instructions and/or one or more commands for the machine 202 to complete worksite tasks within the worksite 200. For example, the wireless signal 212 may include an indication of a particular location at the worksite 200 to which the machine 202 is to relocate. The automation ECM 120 and/or other associated electronic hardware of the machine 202 may process the wireless signal 212 to determine the location within the worksite 200 to which the machine 202 is to be relocated. The automation ECM 120, in cooperation with the main ECM 118, may use any variety of sensors of the machine 202 to control propulsion of the machine 202 to relocate the machine 202 to the desired location at the worksite 200, as indicated by way of the wireless signal 212.

The ROS 214, running the fleet management software 216, is configured to generate the wireless signal 212 that enables the transmission of a task command to the automation ECM 120 of the machine 202 via the antenna 122. For example, the ROS 214, with the fleet management software 216 running thereon, may generate the task command and transmit the same via the wireless signal 212. The ROS 214 may be controlled by an operator 218 (e.g., a worksite 200 manager, construction worker, miner, farmer, paver, etc.) in some cases. Thus, the ROS 214, with the fleet management software 216 running thereon, may receive input from the operator 218, such as via one or more human machine interface(s) (HMIs), to proceed with generating the task command. It should be understood that the ROS 214 may be implemented as multiple devices and/or as a distributed system. The ROS 214 may, in some cases, optimize fleet assignments. Further still, the ROS 214 may include artificial intelligence and/or machine learning algorithms to forecast road deterioration patterns to report and to schedule future road repair to minimize unplanned downtime.

The human operator 218 may provide any variety of parameters, corresponding to desired operating characteristics of the machine 202 for the completion of the worksite task, such as destination location, predetermined intervals for sending location data, speed, etc. These parameters may be encoded by the ROS 214 into the task command that is transmitted to the one or more machines 202 via the wireless signal 212. In some cases, the ROS 214 may be housed in a control center 220 disposed at the worksite 200.

The ROS 214, with the fleet management software 216 operating thereon, is further configured to communicate with the automation ECM 120 of the machine 202 to send a task command and/or receive a worksite task completion notification. The machine 202 and its automation ECM 120 may receive the task command and perform the task encoded thereon. Then, the machine 202, after completing the assigned worksite task, sends a notification indicating completion of the assigned worksite task, such as via the wireless signals 212, to the ROS 214 that commanded the worksite task of the machine 202. The ROS 214, upon receiving the indication of completion of the worksite task, is further configured to display a task completion notification on a display of the ROS 214. Such a task completion notification is configured for viewing by the operator 218, for example.

The ROS 214 communicates with the machine 202 wirelessly. In some instances, the communications between the ROS 214 and the machines 202 may be via protocol based communications (e.g., direct Wi-Fi, Wi-Fi, the Internet, Bluetooth, etc.), and in other instances, the communications may be non-protocol-based communications (e.g., remote control). In examples of the disclosure, the communications between one or more machines 202 and the ROS 214 may be enabled by a worksite level network, such as a local area network (LAN) or a wide-area network (WAN). In alternative examples, the ROS 214 may be incorporated in and/or otherwise hardwired to the machine 202.

Although the ROS 214 is depicted herein as a smartphone, it should be understood that the ROS 214 may be any suitable electronic device. For example, the ROS 214 may be a computer, a mobile device, a server, a tablet computer, a notebook computer, a handheld computer, a workstation, a desktop computer, a laptop, any variety of user equipment (UE), a network appliance, an e-reader, a wearable computer, a network node, a microcontroller, a smartphone, or another computing device. The fleet management software 216 that operates on the ROS 214 to enable it to control the worksite task functionality of the machines 202 may be downloaded to the ROS 214 from any suitable source, such as a commercial app downloading website, USB, or the like.

According to examples of the disclosure, the ROS 214 may receive the RSQ index values, as being transmitted by a machine 202 via the wireless signals 212. The ROS 214 may further compare the RSQ index values to one or more threshold values. Based upon these comparisons, the ROS 214 may ascribe a particular zone to the surfaces of the worksite 200, as determined from location data corresponding to the RSQ index values. For example, the ROS 214 may ascribe a three-tier zone to locations on the surface of the worksite 200, where the three zones may be a high speed zone (smooth surface regions), a medium speed zone (moderate roughness regions), and low speed zone (high roughness regions). Continuing with this example, the ROS 214 may identify each of these three zones by comparing a particular location's RSQ index value to two different threshold values. If the RSQ index value is less than both threshold values, then the particular location may be ascribed the high speed zone. If the RSQ index value is greater than a first threshold value, but less than the second threshold value, then the particular location may be ascribed the medium-speed zone. Finally, if the RSQ index value is greater than both threshold values, then the particular location may be ascribed the low-speed zone. It should be understood that the three tier/two threshold zoning scheme is merely an example, and that the disclosure herein contemplates any suitable number of tiers and/or threshold levels. In this way, the ROS 214 can provide heat maps related to the surface quality at the worksite 200.

The ROS 214 may receive location data (e.g., GPS coordinates, LiDAR data) from individual machines 202 at the worksite 200 via the wireless signals 212. This location data may be received in the same or adjacent communications as the RSQ index data from the machine 202. In other cases, the location data may be received by the ROS 214 in a different stream than the RSQ index data, in which case, the ROS 214 may correlate the received location data with the RSQ index data received from a machine 202. The received location data from the machine 202 may be specified in any suitable manner, such as latitude and longitude coordinates, a worksite 200 specific coordinate system, feature identification (i.e., work area 204). It is from the correspondence of the location data with that the RSQ index data that allows the ROS 214 to generate zone information for the worksite 200.

The ROS 214 generates and/or manages a sitewide model to track the various worksite tasks to be completed at the worksite 200, and the machines 202 available to complete such worksite tasks. According to examples of the disclosure, the ROS 214 may enhance the sitewide model with the worksite level zoning data. In other words, the ROS 214 may generate a map of the worksite 200 where zones or regions where machine 202 operations are to be modified are indicated. As a machine 202 travels across zones, the ROS 214 may instruct changes in the operation of that machine 202, in accordance with the zone being entered.

According to examples of the disclosure, the ROS 214 is configured to generate and disseminate task commands to machines 202 at the worksite 200 to enable the machines 202 to operate in a semi-autonomous manner, where an operator is not needed for each individual machine 202. Thus, the ROS 214 is configured to generate task commands for a single machine 202 or a fleet of machines 202. Therefore, the ROS 214 generates task commands responsive to an interaction with the operator 218 (e.g., the operator 218 instructing a new task to a machine 202), responsive to interactions with one or more machines 202 (e.g., a machine 202 indicating the completion of a task), and/or when a machine 202 crosses a zone.

Referring back to the prior example with three zones (high speed zone, medium speed zone, and low speed zone), the ROS 214 may receive RSQ index values and corresponding location data, as a machine 202 traverses the pathway 206. The received RSQ index values may be greater than other regions as the machine 202 travels over the pothole 208. The received RSQ index values may be even greater as the machine travels over the pothole 210. Thus, in this example, the ROS 214 may ascribe a low speed zone that includes the pothole 210, a medium speed zone that includes the pothole 208, and a high speed zone for the remainder of the pathway 206. In this way, the ROS 214 assigns operating zones to different locations of the worksite 200.

The ROS 214 may further use the operating zones to command or modify the operations of machines 202 when passing form one zone to another. For example, with the preceding example, the ROS 214 may instruct a machine 202 passing from the high speed zone to the medium speed zone, where the pothole 208 is located, to reduce its speed. This minimizes wear and tear on the machine 202 when it travels over the pothole 208. Similarly, the ROS 214 may instruct the machine 202 passing from the medium speed zone to the low speed zone, where the pothole 210 is located, to reduce its speed again. Another machine 202 may be traveling from the low speed zone to the medium speed zone and the ROS 214 may instruct that machine to speed up as the machine enters the medium speed zone. Thus, the ROS 214 may monitor the movement of machines 202 at the worksite and command a change in operation or speed when a machine 202 moves from one zone to another. In some cases, instead of instructing a change of speed, the ROS 214 may command a machine 202 to reroute its movement to avoid particular zones, such as the zone that includes pothole 210.

The ROS 214 may further be configured to monitor the surface quality of regions at the worksite over time, as more machines 202 pass over those regions and report their RSQ indices. The ROS 214 may identify regions with deteriorating surface conditions to highlight to the operator 218. The ROS 214 may indicate these regions that are deteriorating to be avoided and/or reconditioned/repaired.

It should be understood that the functions of the ROS 214, as disclosed herein, may alternatively be performed by the machines(s) 202 in a distributed manner. For example, a machine 202 may indicate various impediments of the surface of the worksite 200 to other machines 202. The machines 202 may also generate their own heat-maps locally based at least in part on RSQ data generated by itself or by other machines 202. In some cases, the machines 202 may generate and/or maintain a distributed ledger, such as a blockchain ledger to track and notify machines of zones and/or impediments at the worksite 200.

It should be understood that the ROS 214 advantageously receives information form a plurality of machines 202 and commands a fleet of machines 202 using worksite surface quality learning garnered from any of the machines 202 at the worksite 200. Thus, the ROS 214 serves as both a repository of worksite surface quality across the worksite 200 and a command center that modifies machine 202 operations based at least in part on the information about the surface quality at various locations at the worksite 200. By modifying machine 202 operations (e.g., speed, routes, etc.) when traveling over impediments, as disclosed herein, the wear and tear on machines are reduced, leading to lower maintenance downtime, greater equipment usage ratios, and greater worksite efficiency, as well as greater machine 202 operation lifetimes.

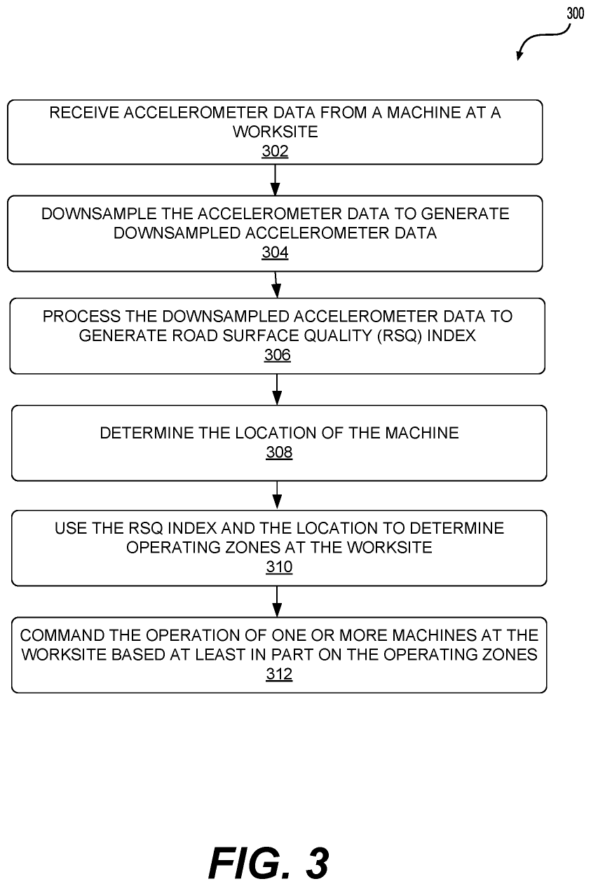

FIG. 3 illustrates a flowchart that depicts an example method 300 for operating a machine 202 while taking into consideration the worksite surface conditions, according to examples of the disclosure. The operations of method 300 may be performed by the main ECM 118, the automation ECM 120, and the remote operating station (ROS) 214.

At block 302, accelerometer data is received from a machine 202 at a worksite 200. The accelerometer data may be received from the one or more accelerometers 116 of the machine 202, such as in the form of a stream with any suitable frequency (e.g., 100 Hz). The accelerometer data may include vertical acceleration data collected as the machine 202 traverses surfaces of the worksite 200. In some cases, the accelerometer data may be received by the main ECM 118 in communications with the accelerometers 116. In other cases, the accelerometer data may be received by the automation ECM 120 with out the involvement of the main ECM 118.

At block 304, downsampled accelerator data may be generated by down-sampling the acceleration data. The down-sampling may be performed by discarding data points within the series of accelerometer data. For example, if the accelerometer 116 provides data at a rate of 100 Hz and a downsampled rate of 50 Hz is needed, then the down-sampling process may involve discarding every other accelerometer data point. In a different example, if the accelerometer 116 provides data at a rate of 150 Hz and a downsampled rate of 30 Hz is needed, then the down-sampling process may involve discarding every four out of five accelerometer data points. The aforementioned numbers are merely examples, and the disclosure contemplates any suitable accelerometer data rate and downsampled accelerometer data rate. This down-sampling operation is optional, since in some cases, the accelerometer 116 may provide the data at a rate that is suitable for further processing.

At block 306, the downsampled accelerator data is processed to generate road surface quality (RSQ) index values. As discussed herein, an optional anti-aliasing operation may be performed, where high-frequency components may be filtered out of the downsampled accelerometer data by filtering out frequency components above a certain threshold (e.g., 25 Hz). A low pass filter (LPF) may be used to filter out high-frequency components from the downsampled accelerometer data. It should be understood that the threshold frequency for the LPF may depend on the type and weight of the machine 202. In general, the sampling frequency of the downsampled acceleromter data should be at least twice that of the highest frequency components of the downsampled accelerometer data to prevent aliasing errors.

After optionally anti-alias filtering the acceleromter data or the downsampled accelerometer data, the anti-aliasing filtered and downsampled accelerometer data may be squared (e.g., the vertical acceleration, \ddot{z}ₖ, is squared) and a moving average may be determined for the squared anti-aliasing filtered and downsampled data. As discussed herein, the calculation of the RSQ index may be according to Equation 1. After determining the RSQ index values, the automation ECM 120 may send those RS index values to the ROS 214, such as in a continuous stream of RSQ index values. Other signal processing operations may also be implemented, such as filtering the vertical acceleration data through a bandpass filter to filter out both low frequency and high frequency noise that is unlikely to be from traveling over impediments or a rough surface.

It should be understood that there may be a variety of alternative calculations, with respective threshold values, that can be used to determine alternate RSQ index values. For example, a moving average of the absolute value of the vertical acceleration data may be used, instead of the square of the vertical acceleration data. With the use of two accelerometers 116, a difference in the vertical acceleration data received from each of the accelerometers 116 may be used to determine the RSQ index values. The difference in vertical acceleration from the two accelerometers 116 may result in filtering of noise (e.g., engine noise) in the difference data. An absolute value or a square of the difference may be taken and passed through a moving average filter to generate an alternate RSQ index.

At block 308, the location of the machine 202 is determined. The location may be determined from GPS coordinates, LiDAR data, and/or other location data provided by the location sensor 124 to one of the main ECM 118 and/or the automation ECM 120. The main ECM 118 and/or the automation ECM 120 may transmit the location data to the ROS 214 via wireless signals 212. The ROS 214 may correlate the location data with the corresponding RSQ index values. In some cases, the ROS 214 may receive the location data and the RSQ index values at the same time, in the same data packets, and/or in an interleaved fashion, which makes it easier for the ROS 214 to correlate and/or organize the two streams of information (e.g., the RSQ index data and the location data).

At block 310, the ROS 214 uses the RSQ index values and the location to determine operating zones at the worksite 200. The ROS 214 may compare the RSQ index values to one or more threshold values. Based upon these comparisons, the ROS 214 may ascribe a particular zone to the surfaces of the worksite 200, as determined from location data corresponding to the RSQ index values. For example, the ROS 214 may ascribe a two-tier zone to locations on the surface of the worksite 200, where the two zones may be a high-speed zone (smooth surface regions) and a low speed zone (high roughness regions). Continuing with this example, the ROS 214 may identify each of these three zones by comparing a particular location's RSQ index value to a threshold values. If the RSQ index value is less than the threshold value, then the particular location may be ascribed the high speed zone. If the RSQ index value is greater than the threshold value, then the particular location may be ascribed the low speed zone. It should be understood that the two tier/one threshold zoning scheme is merely an example, and that the disclosure herein contemplates any suitable number of tiers and/or threshold levels.

At block 312, the ROS 214 commands operation of one or more machines at the worksite 200 based at least in part on the operating zones. As the ROS 214 tracks different machines 202 at the worksite 200 based at least in part on receive location data, the ROS 214 may identify machine(s) 202 that travel across zones. The ROS 214 may generate and send a command to the machines 202 that enter a new zone to abide by the speed limits of that zone. In this way, the ROS 214 controls the speed of the machines 202 responsive to the travel impediments at different locations at the worksite 200. The ROS 214 may further use the RSQ data for future fleet management and machine 202 deployment and/or schedule road repair and/or maintenance. The ROS 21 may also employ artificial intelligence and/or machine learning to predict future maintenance to minimize unexpected downtime.

It should be noted that some of the operations of method 300 may be performed out of the order presented, with additional elements, and/or without some elements. Some of the operations of method 300 may further take place substantially concurrently and, therefore, may conclude in an order different from the order of operations shown above. It should also be noted that in some cases, there may be other components of the machine 202 or the worksite 200 involved in one or more of the operations, as described herein.

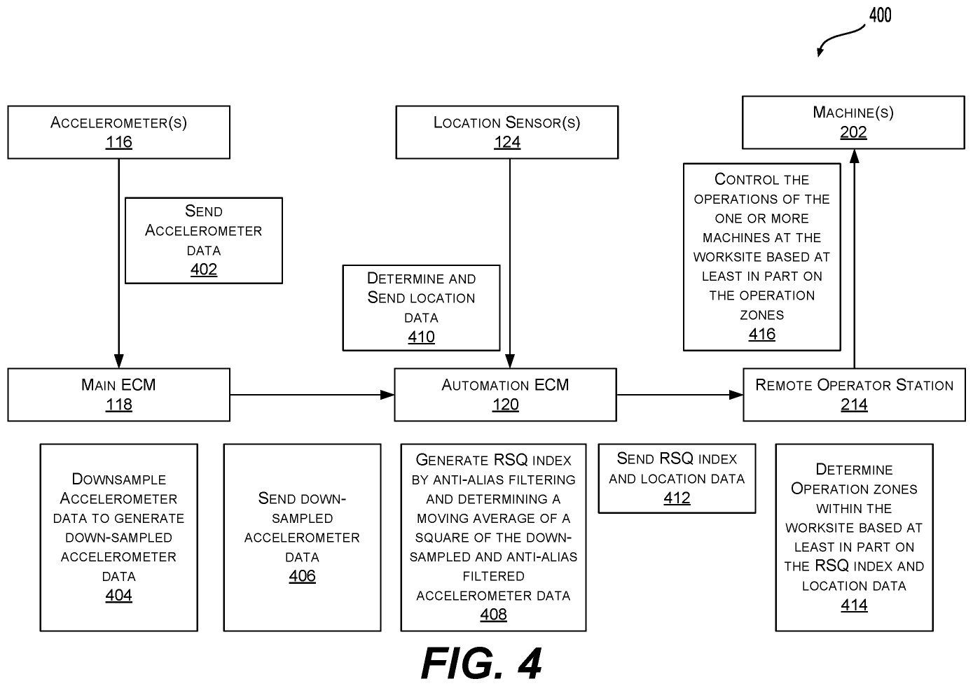

FIG. 4 illustrates a block diagram that depicts an example method 400 for determining worksite surface conditions and controlling machines 202 at the worksite 200, according to examples of the disclosure. The operations of method 400 are performed by the main ECM 118, the automation ECM 120, and the remote operating station (ROS) 214.

As shown, at operation 402, the accelerometer(s) 116 may send accelerometer data to the main ECM 118. The accelerometer data may include vertical acceleration data. At operation 404, the main ECM 118 may downsample the accelerometer data to generate down-sampled accelerometer data. Next, at operation 406, the main ECM 118 may send the down-sampled vertical acceleration data to the automation ECM 120. The automation ECM 120, at operation 408, may generate the RSQ index by anti-alias filtering the down-sampled vertical acceleration data and then determining a moving average of a square of the down-sampled and anti-alias filtered vertical acceleration data.

The automation ECM 120, at operation 410, may receive location data from the location sensor 124. At operation 412, the automation ECM 120 may send the RSQ index and the location data to the ROS 214. The ROS 214, at operation 414, may determine operation zones within the worksite 200 based at least in part on the RSQ index and the location data. At operation 416, the ROS 21 may control the operations of one or more machines 202 at the worksite 200 based at least in part on the operation zones.

It should be noted that some of the operations of method 400 may be performed out of the order presented, with additional elements, and/or without some elements. Some of the operations of method 400 may further take place substantially concurrently and, therefore, may conclude in an order different from the order of operations shown above. It should also be noted that in some cases, the operations described may be performed by entities other than the ones to which the operations are ascribed. For example, the disclosure contemplates that the actions of the main ECM 118, the automation ECM 120, and the ROS 214 may be interchangeable.

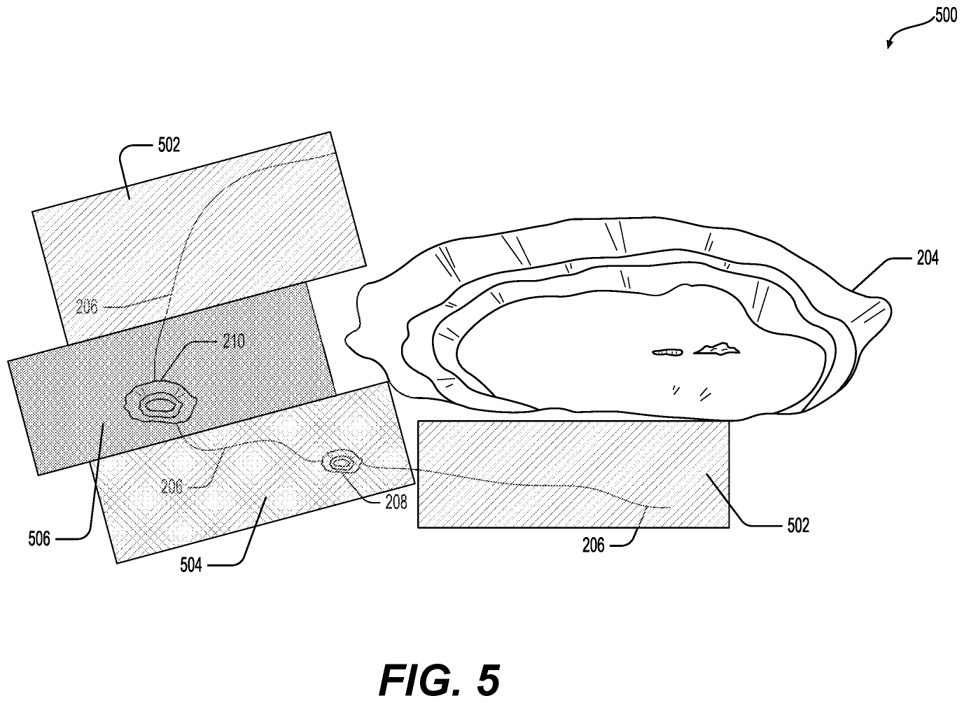

FIG. 5 is a schematic illustration of an example map 500 of the example worksite of FIG. 2 with various operating zones 502, 504, 506, according to examples of the disclosure. As shown, a three-tiered zoning scheme is used with a fast speed zone 502, a medium speed zone 504, and a low speed zone 506. It should be understood that the disclosure alternatively contemplates any number of different zones, such as two zones, four zones, five zones, etc. The map 500, as shown here, may be displayed on the ROS 214, to be viewed by the operator 218. The low speed zone 506 may include large impediments, such as pothole 210. In comparison, the medium speed zone 504 may include smaller or fewer impediments, such as pothole 208, than those in the low speed zone 506.

The map 500 may be used by the ROS 214 to dispatch commands to the machines 202 at the worksite to slow down as machines 202 travel from zone 502 to zone 504 or from zone 504 to zone 506 or from zone 502 to 506. Similarly, the ROS 214 may dispatch commands to speed up to machines 202 that travel from zone 504 to zone 502 or from zone 506 to zone 504 or from zone 506 to zone 502. Alternatively, the ROS 214 may direct the machines 202 at the worksite 200 to take an alternate to pathway 206 at zone 506 and/or zone 504. In other words, in some cases, the ROS 514 may redirect machines 202 to avoid impediments at the worksite 200, as identified by the apparatus, systems, and methods herein.

In some cases, the ROS 214 may also track the ongoing quality of the surface of the worksite 200 over time and indicate, such as to the operator 218, regions that are deteriorating over time. Thus, the ROS 214 may provide guidance as to regions of the worksite 200 that may be in need of operational changes, avoidance, attention, and/or repair.

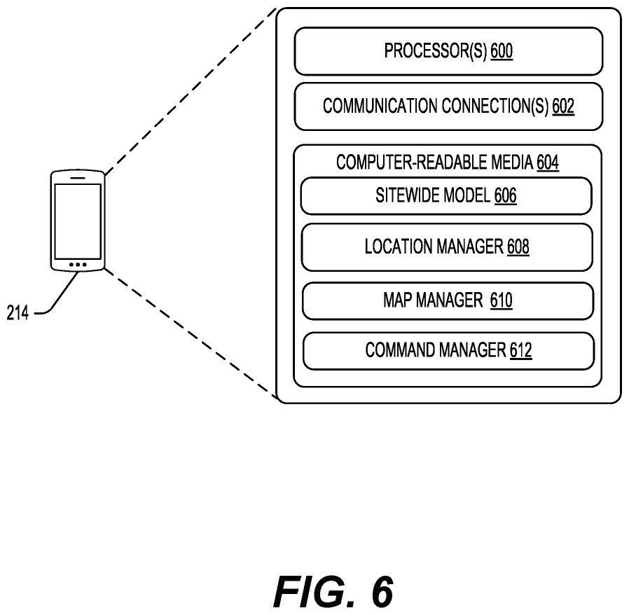

FIG. 6 is a block diagram of an example remote operator station (ROS) 214 that provides commands to machines 202 at the worksite 200, according to examples of the disclosure. The ROS 214 includes one or more processor(s) 600, one or more communication interface(s) 602, and computer-readable media 604.

In some implementations, the processors(s) 600 may include a central processing unit (CPU), a graphics processing unit (GPU), both a CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 600 may possess its own local memory, which also may store program modules, program data, and/or one or more operating systems. The one or more processor(s) 600 may include one or more cores.

The communications interface(s) 602 may enable the ROS 214 to communicate via the one or more network(s), such as via the wireless signals 212. The communications interface(s) 602 may include a combination of hardware, software, and/or firmware and may include software drivers for enabling any variety of protocol-based communications, and any variety of wireline and/or wireless ports/antennas. For example, the communications interface(s) 702 may comprise one or more of WiFi, cellular radio, a wireless (e.g., IEEE 802.1x-based) interface, a Bluetooth® interface, and the like. In some cases, if a remote control is used to control the machine 202, the communications interface(s) 602 may enable the use of remote-control signals to communicate with the machine 202.

The computer-readable media 604 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 604 may be implemented as computer-readable storage media (CRSM), which may be any available physical media accessible by the processor(s) 600 to execute instructions stored on the computer-readable media 604. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 600. The computer-readable media 604 may have an operating system (OS) and/or a variety of suitable applications stored thereon. The OS, when executed by the processor(s) 600 may enable management of hardware and/or software resources of the ROS 214.

Several components such as instruction, data stores, and the like may be stored within the computer-readable media 604 and configured to execute on the processor(s) 600. The computer-readable media 604 may have stored thereon a sitewide model 606, a location manager 608, a map manager 610, and a command manager 612. It will be appreciated that each of the components 606, 608, 610, 612 may have instructions stored thereon that when executed by the processor(s) 600 may enable various functions pertaining to completion of worksite tasks by the machine 202, as described herein.

The instructions stored in the sitewide model 606, when executed by the processor(s) 600, configure the ROS 214 to track machines 202 at a worksite 200, as well as instructs sent or to be sent to the various machines 202. The processor(s) 600 may also ascribe different operating zones to different parts of the worksite 200 and, in some cases, display a map of the worksite 200 with various operating zones thereon.

The instructions stored in the location manager 608, when executed by the processor(s) 600, configures the ROS 214 to receive location data from one or more machines 202 at a worksite 200. The processor(s) 600 may further correlate the location data with received RSQ data from the machines 202.

The instructions stored in the map manager 610, when executed by the processor(s) 600, configure the ROS 214 to may generate and/or display a worksite map to show the location various machines 202 at the worksite 200, as well as the locations of impediments at the worksite discovered by the disclosure herein. The processor(s) 600 may also determine when machines are crossing operating zones at the worksite 200, as represented on the map.

The instructions stored in the command manager 612, when executed by the processor(s) 600, configure the ROS 214 to dispatch commands to various machines 202 at a worksite 200. The commands may be task commands to perform specific tasks at the worksite 200. The command may also be to change operations of machines 202 as they approach identified impediments at the worksite 200.

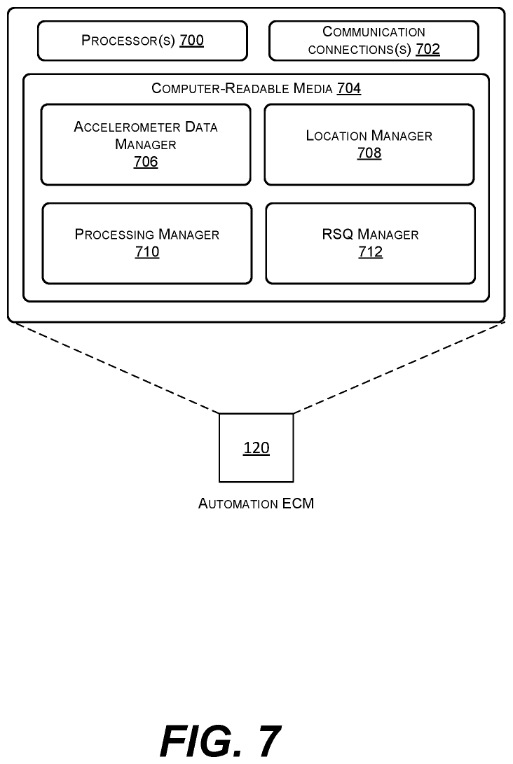

FIG. 7 is a block diagram of an example automation electronic control module (ECM) 120 that provides RSQ index data to the remote operator station 214, according to examples of the disclosure. The automation ECM 120 includes one or more processor(s) 700, one or more communication interface(s) 702, and computer-readable media 704. The descriptions of the one or more processor(s) 700, the one or more communication interface(s) 702, and the computer-readable media 704 may be substantially similar to the descriptions of the one or more processor(s) 600, the one or more communication interface(s) 602, and the computer-readable media 604, as described in conjunction with FIG. 6 herein, and in the interest of brevity, will not be repeated here.

Several components such as instruction, data stores, and the like may be stored within the computer-readable media 704 and configured to execute on the processor(s) 700. The computer-readable media 704 may have stored thereon accelerometer data manager 706, a location manager 708, a processing manager 710, and an RSQ manager 712. It will be appreciated that each of the components 706, 708, 710, 712 may have instructions stored thereon that when executed by the processor(s) 700 may enable various functions pertaining to providing RSQ index data, as described herein.

The instructions stored in the accelerometer data manager 706, when executed by the processor(s) 700, configure the automation ECM 120 to receive acceleration data, either directly from the accelerometers 116 or from the main ECM 118 or other entity. The accelerometer data may be stored, such as in memory, for further processing.

The instructions stored in the location manager 708, when executed by the processor(s) 700, configure the automation ECM 120 to receive location data, such as form the location sensor 124 and transmit that data to the ROS 214. In some cases, the location data may be temporarily cached.

The instructions stored in the processing manager 710, when executed by the processor(s) 700, configure the automation ECM 120 to process the accelerometer data. The processor(s) 700 may be configured to apply a moving average filter, a low pass filter, an anti-aliasing filter, a bandpass filter, or any other signal processing tools.

The instructions stored in the RSQ manager 712, when executed by the processor(s) 700, configure the automation ECM 120 to calculate the RSQ index values associated with one or more of the accelerometers 116. The processor(s) 700 may further be configured to transmit the RSQ index values to the ROS 214, such as in a continuous stream of data.

### INDUSTRIAL APPLICABILITY

The present disclosure describes systems and methods for providing dynamic control of autonomous or semi-autonomous machines 202 at a worksite 200 in a manner where the machines 202 slow down when traversing locations at the worksite 200 that have rough or difficult to traverse surfaces. The use of autonomous or semi-autonomous machines 202 allow for greater worksite productivity, as a fewer number of operators 218 may be needed to perform tasks at the worksite 200. This is advantageous, as worksite tasks can be accomplished with lower levels of human labor intensity, improving work and financial efficiencies.

However, without the apparatus, systems, and methods disclosed herein, the machines 202, when controlled remotely, may not operate in a manner that takes into account impediments and/or roughness of surfaces over which the machines 202 travel. This may lead to greater wear and tear on the machines 202, when they do not slow down for or avoid obstacles in their path, as human operated machine would. This leads to wear and tear, greater maintenance needs, and overall reduced lifetime of the machines 202.

The improvements disclosed herein allows for learning the terrain of the worksite 200 and operate the machines 202 accordingly. Impediments and poor surface conditions at the worksite 200 are identified and machines 202 are operated in a manner such that the machines slow down or avoid the impediments at the worksite 200. As a result, the machines 202 may be subject to reduced wear and tear, greater time between maintenance, and overall greater lifetime of the machines 202. This results in improved financial metrics related to capital expenditures, such as greater return on investment (ROI) and return on capital (ROC), as well as greater productivity from other worksite 200 assets.

Although the systems and methods of machines 202 are discussed in the context of mining operations, it should be appreciated that the systems and methods discussed herein may be applied to a wide array of machines and vehicles across a wide variety of industries, such as construction, mining, farming, transportation, military, combinations thereof, or the like. For example, the semi-autonomous control mechanism of machines 202 with operational changes responsive to road surface quality, as disclosed herein, may be applied to a compactor in the paving industry or a harvester in the farming industry. It should also be understood that the worksite 200 surfaces traversed by the machines 202 may be underground, such as inside of mining tunnels.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

1. A system comprising:
an antenna;
an accelerometer;
a remote operating station (ROS) including a processor;
at least one electronic control module (ECM) in communication with the antenna and the accelerometer; and
a non-transitory computer-readable media having stored thereon computer-executable instructions that, when executed, cause the at least one ECM to:
receive vertical acceleration data from the accelerometer as a machine traverses a surface;
determine, based at least in part on the vertical acceleration data, a series of road surface quality (RSQ) index values;
send, as a wireless signal via the antenna, the series of RSQ index values to the ROS;
receive, from the ROS, a command to implement in a change in speed of the machine based at least in part on the series of RSQ index values; and
implement the change in speed of the machine.

2. The system of claim 1, wherein the computer-executable instructions, when executed, cause the at least one ECM to:
receive, from the ROS, a second command to implement a second change in operation of the machine, wherein the second command is based at least in part on a second series of RSQ index values generated by a second machine; and
implement the second change in operation of the machine.

3. The system of claim 1, wherein the computer-executable instructions, when executed, cause the at least one ECM to:
generate down-sampled vertical acceleration data by deleting one or more individual ones of the vertical acceleration data.

4. The system of claim 1, wherein the computer-executable instructions, when executed, cause the ECM to:
generate low-pass filtered vertical acceleration data by applying an anti-aliasing filter to the vertical acceleration data.

5. The system of claim 4, wherein the anti-aliasing filter includes a low pass filter to filter out vertical acceleration data with frequencies exceeding 25 Hz.

6. The system of claim 1, wherein the computer-executable instructions, when executed, cause the at least one ECM to:
generate the RSQ index values by determining a moving average of a square of the vertical acceleration data.

7. The system of claim 1, wherein the computer-executable instructions, when executed, cause the at least one ECM to:
generate down-sampled vertical acceleration data by deleting one or more individual ones of the vertical acceleration data;
generate anti-aliasing filtered and down-sampled vertical acceleration data by applying an anti-aliasing filter to the down-sampled vertical acceleration data; and
generate the RSQ index values by determining a moving average of a square of the anti-alias filtered and down-sampled vertical acceleration data.

8. The system of claim 1, further comprising:
a second accelerometer, wherein the computer-executable instructions, when executed, cause the at least one ECM to:
receive, from the second accelerometer, second vertical acceleration data as the machine traverses the surface;
determine, based at least in part on the second vertical acceleration data, a second series of RSQ index values; and
send, as a second wireless signal and via the antenna, the second series of RSQ index values to the ROS, wherein the command to implement the change in operation is based at least in part on the second series of RSQ index values.

9. The system of claim 1, wherein the ROS is configured to:
receive the series of RSQ index values;
determine, based at least in part on the series of RSQ index values, that a first location at a worksite is associated with a first zone;
determine, based at least in part on the series of RSQ index values, that a second location at the worksite is associated with a second zone, wherein the first zone is associated with a slower operating speed than the second zone;
determine that a second machine is to travel from the first location to the second location; and
send, to the second machine, a command for the second machine to speed up, responsive to the second machine traveling from the first location to the second location.

10. The system of claim 9, wherein the ROS is configured to:
determine that a third machine is enroute to the first zone; and
send, to the third machine, a second command to reroute the third machine to avoid entering the first zone.

11. A method comprising:
receiving, from an accelerometer of a machine and by an electronic control module (ECM) of the machine, acceleration data;
generating, by the ECM and based at least in part on the acceleration data, a down-sampled acceleration data by deleting one or more individual ones of the acceleration data;
generating, by the ECM, anti-aliasing filtered and down-sampled acceleration data by applying an anti-aliasing filter to the down-sampled acceleration data;
generating, by the ECM, road surface quality (RSQ) index values by determining a moving average of a square of the anti-alias filtered and down-sampled acceleration data;
sending, by the ECM and to a remote operating station (ROS), the RSQ index values;
receiving, by the ECM and from the ROS, a command to change a route of the machine, wherein the command is based at least in part on the RSQ index values; and
implementing, by the ECM, the change in the route of the machine.

12. The method of claim 11, further comprising:
receiving, by the ECM and from the ROS, a second command to change an operation of the machine, wherein the second command is based at least in part on second RSQ index values associated with a second machine; and
implementing, by the ECM, the change in the operation of the machine.

13. The method of claim 11, wherein sending the RSQ index values comprises continuously streaming the RSQ index values to the ROS.

14. The method of claim 11, further comprising:
receiving, from a second accelerometer of the machine and by the ECM, second acceleration data;
generating, by the ECM and using the second acceleration data, second RSQ index values; and
sending, by the ECM and to the ROS, the second RSQ index values.

15. A machine comprising:
an antenna;
an accelerometer;
an electronic control module (ECM) in communication with the antenna and the accelerometer; and
non-transitory computer-readable media storing computer-executable instructions that, when executed, cause the ECM to:
receive vertical acceleration data from the accelerometer as the machine traverses a surface;
determine, based at least in part on the vertical acceleration data, a series of road surface quality (RSQ) index values;
determine, based at least in part on the series of RSQ index values, that the machine is to change at least one of speed or route; and
implement the change of at least one of the speed or the route.

16. The machine of claim 15, wherein the computer-executable instructions, when executed, cause the ECM to:
determining a location where the at least one of the speed or the route are to be changed; and
communicate the location to a second machine.

17. The machine of claim 16, wherein the computer-executable instructions, when executed, cause the ECM to:
store the location in an immutable ledger, wherein the immutable ledger is accessible by the second machine.

18. The machine of claim 17, wherein the computer-executable instructions, when executed, cause the ECM to:
receive, from the immutable ledger, a command to decrease speed; and
implement, the decrease in speed.

19. The machine of claim 15, wherein the computer-executable instructions, when executed, cause the ECM to:
transmit, to a remote operating station (ROS) via the antenna, the series of RSQ index values; and
receive, from the ROS, a command to change a speed of the machine.

20. The machine of claim 15, wherein the computer-executable instructions that, when executed, cause the ECM to:
generate down-sampled vertical acceleration data by deleting one or more individual ones of the vertical acceleration data;
generate anti-aliasing filtered and down-sampled vertical acceleration data by applying an anti-aliasing filter to the down-sampled vertical acceleration data; and
generate the RSQ index values by determining a moving average of a square of the anti-alias filtered and down-sampled vertical acceleration data.
